(19) United States
(12) Patent Application Publication
(10) Pub. No.: US 2014/0164068 A1
(43) Pub. Date: Jun. 12, 2014

(54) PROCESS TOOL

(71) Applicant: True North International Pty Ltd., North Sydney (AU)

(72) Inventor: Philip Vincent Lori, Sorrento (AU)

(73) Assignee: True North International Pty Ltd., North Sydney (AU)

(21) Appl. No.: 13/949,533

(22) Filed: Jul. 24, 2013

(30) Foreign Application Priority Data
Jul. 24, 2012 (AU) 2012903180

(51) Int. Cl. G06Q 10/06

(52) U.S. Cl. CPC G06Q 10/0637
USPC 705/7.36

(57) ABSTRACT

A process tool is described that comprises a data input application implemented by a computing device and arranged to facilitate definition of business process information by a user. The process too includes a plurality of user selectable industry value maps, each industry value map defining a library of metric information and graphical representations relevant to a particular industry. The process tool is arranged to facilitate selection using the computing device of an industry value map by a user and to use information and graphical representations associated with the industry value map to define a framework to support a business conversation. The process tool is also arranged to produce materials using the business process information defined by the user according to the framework at least partly populated using the industry value map.

### FIELD OF THE INVENTION

The present invention relates to a process tool for documenting business process information and presenting the information such that the information is suitable for supporting a business conversation.

### BACKGROUND OF THE INVENTION

In modern commerce, in order for a business to sell products to multiple industries having different decision makers with different key performance indicators, access to consistent, structured business process research and presentation information is required.

However, current commerce methods for gathering and using this information are cumbersome and relatively ineffective.

### SUMMARY OF THE INVENTION

In accordance with a first aspect of the present invention, there is provided a process tool comprising:

a data input application arranged to facilitate definition of business process information by a user; and

a plurality of user selectable industry value maps, each industry value map defining a library of metric information and graphical representations relevant to a particular industry;

the process tool being arranged to facilitate selection of an industry value map by a user and to use information and graphical representations defined by the industry value map to populate a framework used to support a business conversation; and

the tool being arranged to produce materials using the business process information defined by the user according to the framework at least partly populated using the industry value map.

In one embodiment, the data input application is arranged to facilitate definition of the business process information by facilitating entry of information by a user and/or selection of information by the user from pre-defined selection menus.

In one embodiment, the data input application is arranged to facilitate definition of the business process information by facilitating definition of the business process information in a plurality of data entry stages.

In one embodiment, the tool is arranged to copy at least some information entered at a data entry stage to at least one other data entry stage.

In one embodiment, each data entry stage is associated with a data entry screen presented to the user by a computing device.

In one embodiment, the data input application is arranged to facilitate definition by a user of a business opportunity that is perceived to exist for a user in relation to a client.

In one embodiment, the data input application is arranged to facilitate definition of a strategy to be used by the user to present the business opportunity to the client.

In one embodiment, the process tool is arranged to facilitate generation of a strategy document, a storyboard document and/or a script document usable to guide the user in a business conversation with the client during which the business opportunity is presented to the client.

In one embodiment, each industry value map includes information structured according to a plurality of business process groups, each business process group having at least one associated business process, each business process separated into financial, strategic and operational process categories, and each process category including at least one item linked to at least one business metric. The business metric may be a number, currency value and/or a percentage value.

In one embodiment, the items in each process category may be entered by a user, may correspond to stored default values, or may be obtained from a remote source.

In one embodiment, the data input application is arranged to facilitate definition of a problem that the client is perceived to have, the difficulties that the client is experiencing overcoming the problem, and the benefit believed to exist for the user in providing a solution to the client's problem.

In one embodiment, the data input application is arranged to facilitate definition of current state information indicative of the client prior to implementing a solution to the problem, and future state information indicative of the expected state of the client after implementation of the solution proposed by the user.

The data input application may be arranged to facilitate definition of a problem by facilitating selection of a goal using the selected industry value map, the goal being indicative of a desired change in quantifiable terms to an item in the selected industry value map.

In one embodiment, the tool is arranged to present suggested goals to the user, for example based on the most common goals for the industry associated with the industry value map.

In one embodiment, the future state information includes information indicative of the business and/or capability improvements proposed by the user to assist the client in achieving the selected goal.

In one embodiment, the future state information includes information indicative of the benefits that the user believes the client will receive by implementation of the proposed business and/or capability improvements.

In one embodiment, the data input application is arranged to facilitate entry of information indicative of decision makers associated with the client that are likely to be involved with solving the identified problem.

In one embodiment, the data input application is arranged to facilitate definition of relative strengths of the user and at least one competitor.

In one embodiment, the data input application is arranged to facilitate definition of a plurality of proposed solutions to the identified client problem. The plurality of proposed solutions may correspond to low, medium and high cost solutions and/or solutions associated with conservative, pragmatic or visionary approaches to solving the identified client problem.

In one embodiment, the tool is arranged to produce a value statement indicative of the identified client problem, one or more solutions to the problem proposed by the user, and information indicative of the user's suitability to provide the solution.

In one embodiment, the data input application is arranged to facilitate definition of storyboard information including information indicative of a current state of a client before implementation of the proposed solution to the identified client problem, and a future state of the client after implementation of the proposed solution, each of the current and future state information including at least one graphical representation of a business process item derived from the selected industry value map. The graphical representations may together define a three dimensional visual representation of the physical environment(s) or objects in which the business process takes place.

In accordance with a second aspect of the present invention, there is provided a method of documenting and presenting business process information, the method comprising:

providing a computing device;

using a data input application implemented by the computing device to define business process information;

providing a plurality of user selectable industry value maps, each industry value map defining a library of metric information and graphical representations relevant to a particular industry;

selecting an industry value map by a user;

using information and graphical representations associated with the selected industry value map to define a framework to support a business conversation; and

producing materials using the business process information defined by the user according to the framework at least partly populated using the industry value map.

### BRIEF DESCRIPTION OF THE DRAWINGS

The present invention will now be described, by way of example only, with reference to the accompanying drawings, in which:

FIG. 1 is a schematic block diagram illustrating a business process tool in accordance with an embodiment of the present invention;

FIG. 2 is a schematic block diagram of functional components of the process tool shown in FIG. 1;

FIG. 3 is a flow diagram illustrating steps of a process for creating process documents using the process tool shown in FIG. 1;

FIG. 4 is a flow diagram illustrating an analysis process of the process shown in FIG. 3;

FIG. 5 is a flow diagram illustrating a strategy process of the process shown in FIG. 3;

FIG. 6 is a flow diagram illustrating a document creation process of the process shown in FIG. 3; and

FIGS. 7 to 17 are diagrammatic representations of screens produced by the process tool during use.

### DESCRIPTION OF AN EMBODIMENT OF THE INVENTION

The present process tool assists a user to document, update and present business process models in a way that facilitates clear understanding as to which aspects of the business process can be influenced and which have the most impact on desired outcomes. A business process can be documented and stored as multiple versions so that a user can compare and contrast options and the implications of each option. The process tool is able to produce a series of documents describing a business process with measurement data, analysis output, a visual representation of the business process, and a script that can be used as a guide to discuss the contents of the document in a business meeting.

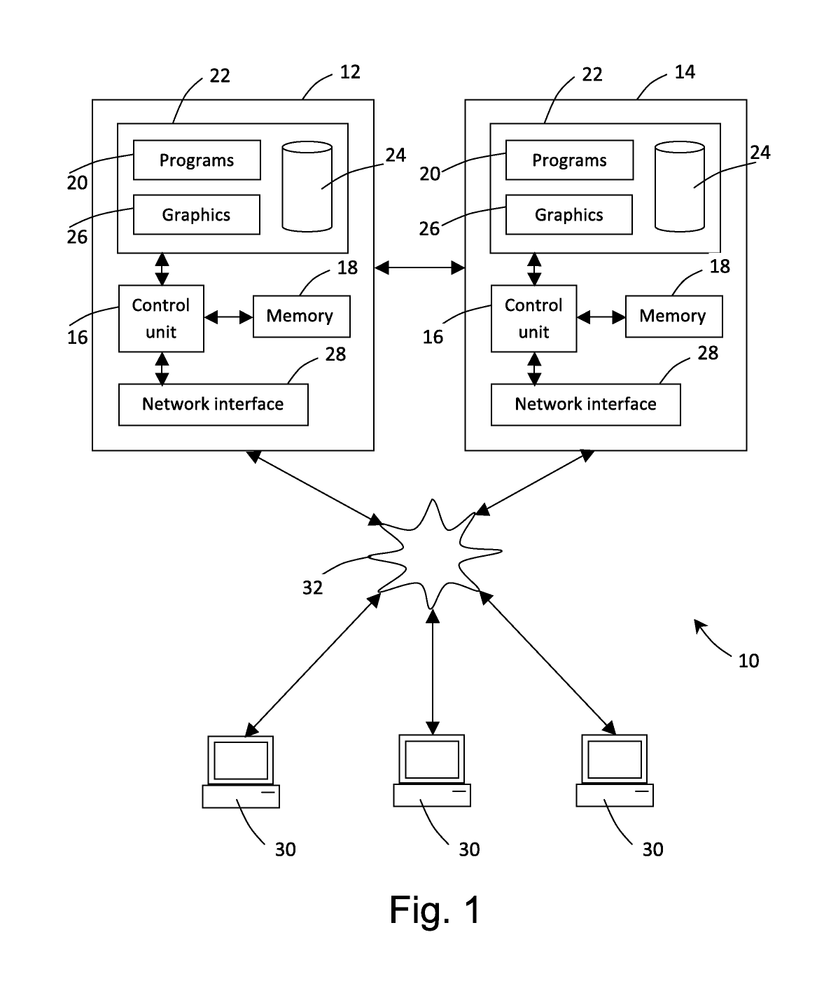

Referring to FIG. 1 of the drawings, there is shown a process tool 10 for documenting business process information and presenting the information such that the information is suitable for supporting a business conversation.

The process tool 10 may be used to assist a person to present a business opportunity to a prospective client or existing client by providing the person with business process documents and a three dimensional visual representation of the physical environment(s) or objects in which the business process takes place. The system also produces a script that can be used as a guide to discuss the contents of the document in a business meeting; that is, to assist a person to engage in a business conversation with a client or a prospective client.

In this way, the person is provided with the tools to present a business opportunity to a prospective or existing client in a structured, directed way that is clear and easy to understand by the client.

For example, the system 10 may be used to present a business opportunity in the form of a new service offering or a new product to a prospective client by facilitating entry and/or selection by a user of information indicative of the business opportunity, facilitating entry and/or selection by a user of information indicative of a strategy to be used to present the business opportunity to the prospective client, and creating and printing documents to be used during a business conversation with the prospective client wherein the new service offering or new product is presented to the prospective client.

In this embodiment, the process tool 10 includes first and second servers 12, 14 that provide real time failover and load balancing by replicating functionality. Each of the first and second servers 12, 14 includes a control unit 16 arranged to control and coordinate operations in the server 12, 14, and a memory 18 used by the control unit 16, for example to execute programs 20 stored in a data storage device 22.

The programs 20 are arranged to provide a user interface, such as a web-based interface and/or networked API, and an automated process engine, implemented by presenting a user with several screens that are used to select and/or enter particular information. The entered and/or selected information is subsequently used by the automated process engine to create documents to support a business conversation that include visual representations of aspects of a business process and data metrics drawn from information stored in the data storage device 22.

For this purpose, the data storage device 22 includes a database 24 arranged to store business process information in a structured way, and graphical representations 26 of aspects of business processes. The graphical representations may be associated with particular business processes in the database such that specific business processes have a particular set of selectable graphical representations relevant to the business process.

The information in the database 24 includes a plurality of industry value maps, each of which is associated with metric information and graphical representations relevant to a particular industry type, such as health, mining, defense, banking, education, emergency services, gaming, government, manufacturing, pharmaceutical, telecoms, transport or utilities.

The database 24 is populated according to an automated process that involves presenting several screens to a user, receiving information inputs and/or selections from the user at each of the screens, and receiving a selection from the user of a relevant industry value map related to the industry type.

Each server 12, 14 also includes a network interface arranged to enable the server 12, 14 to communicate with one or more user terminals 30, in this example through the Internet 32.

It will be understood that each of the servers 12, 14 may be accessible directly and/or through a communications network, such as a LAN and/or the Internet.

In this example, each server 12, 14 comprises a computing device, such as a personal computer, although it will be understood that any suitable computing device is envisaged.

In this example, each user terminal 30 comprises a computing device, such as a personal computer, although it will be understood that any suitable computing device is envisaged, such as a tablet computer or a smartphone.

Each user terminal 30 may be a wired or wireless device and may utilize various technologies and bandwidths, such as LAN, cable, ADSL or wireless (eg WLAN, 3G, 4G) connections. The protocols and interfaces between the user terminals and the servers may also vary according to available technologies, including TCP/IP protocols; GPRS, 3G and/or 4G protocols; and/or proprietary communications protocols.

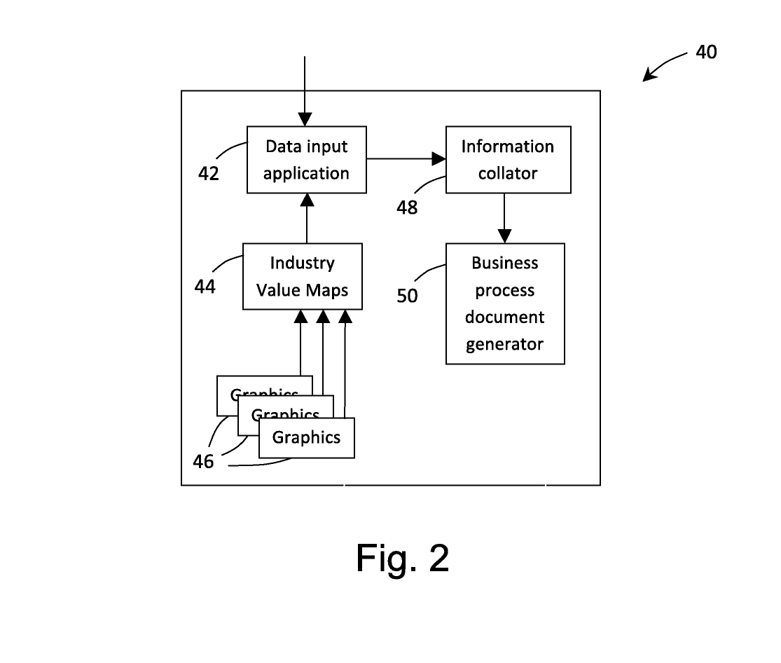

Referring to FIG. 2, a schematic block diagram of functional components 40 of the process tool 10 is shown. The functional components 40 include a data input application 42 arranged to enable a user to enter and/or select information to be used by the system to create documents to support a business conversation, including selection of one of a plurality of industry value maps 44, each of which is associated with a particular industry type and each of which has an associated library of graphical representations 46 related to the industry type.

The functional components 40 also include an information collator 48 arranged to collate information entered and/or selected by a user, and a document generator 50 arranged to facilitate exportation of strategy, storyboard and script documents for use in a business conversation, for example to a particular program such as a spreadsheet, presentation or document viewing program, or to a printer.

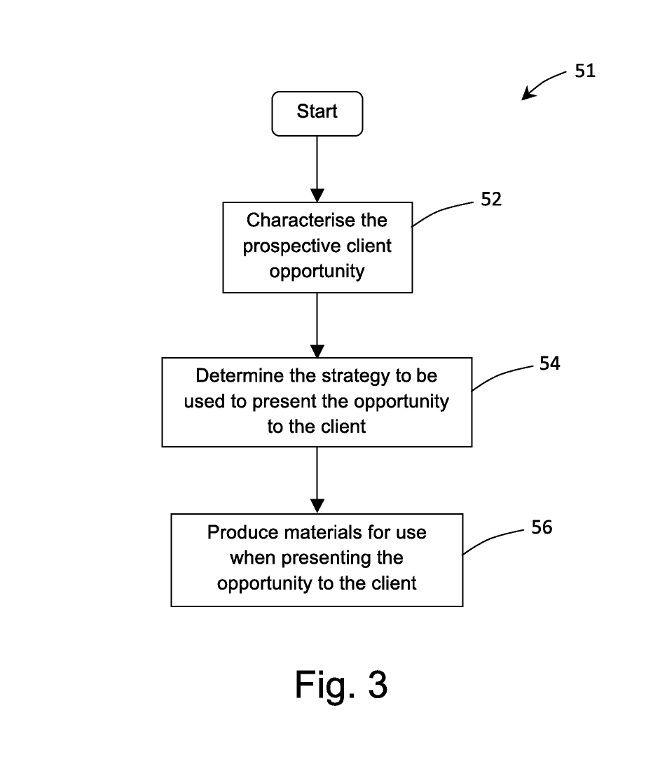

FIG. 3 illustrates an example process 51 for generating documents to be used in a business conversation using the process tool 10 shown in FIG. 1.

The process 50 involves analyzing 52 a client organisation or a prospective client organization (hereinafter ‘a client’) with a view to determining and characterizing a business opportunity that is perceived to exist in relation to the client. For example, the business opportunity may be a new service offering or new product that is proposed to be offered to the client, and the characterization step involves specifying the factors that are believed to influence the client's decision to purchase. For example, the factors may include:
the scope of the client's problem that the new business solves;
the current state of the client in relation to the business problem;
the relationship of the user's organisation (hereinafter ‘the user’) with the key people at the client likely to be involved in making the purchasing decision;
the options that are available to the client and the relative strengths of each.

After the analysis step 52, the process 50 involves developing a strategy 54 whereby the user's service offering or product is matched to the client's problem. The strategy step 54 may involve the following sub-steps:
determine how the user's product/service will impact the client's problem in concrete metrics;
determine the scope of the user's capability and capacity to deliver a solution to the client's problem in the desired timeframe; and
determine the potential future state for the client.

After the strategy step, the process 50 involves generating materials 56 for use in a business conversation with the client wherein the user's product or service is discussed and presented to the client. The materials generation step 56 may include generating a strategy document detailing the strategy, generating a storyboard document including graphical representations of the client before and after implementation of the product or service, and generating a script document that serves as a guide to the structure and flow of information in a meeting with the client about the product or service offering.

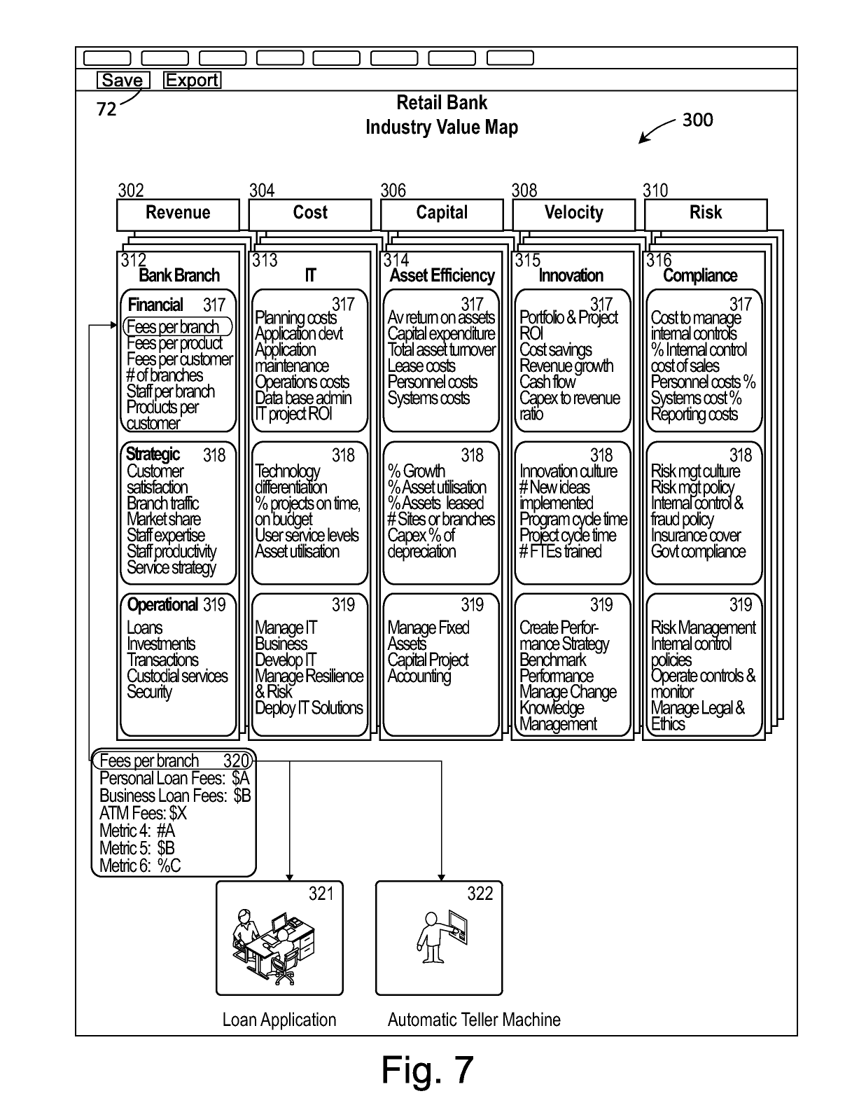

An example industry value map 44 is shown on industry value map screen 300 in FIG. 7. Each industry value map screen 300 is particular to an industry type and describes business process groups 302, 304, 306, 308, 310 relevant to the industry type in a structured framework. Each business process group is separated into three categories corresponding to financial, strategic and operational drivers 317, 318, 319 into which business process metrics are grouped and documented. The industry value maps 44 are used to populate a framework for at least some of the information entered and/or selected by a user in subsequent screens. In particular, in this example, the industry value map 44 is used to select goals/KPIs related to the problem to be solved, and the library of graphical representations that are selectable for inclusion in a storyboard.

In this example, the business process groups include revenue 302, cost 304, capital 306, velocity 308 and risk 310.

Under each group heading, business processes that are related to the heading are described.

The industry value map screen 300 shown in FIG. 7 relates to a retail bank and includes several processes under each business process group. In this example, the process groups 302, 304, 306, 308, 310 include the following processes:

Revenue 302—bank branch 312, ATM revenue, contact centre transactions, and channel partners sales;

Cost 304—marketing and product efficiency, access channel efficiency, operational efficiency, shared services efficiency including information technology 313, finance and accounting, human resources, procurement and business management.

Capital 306—asset efficiency 314 and liability efficiency.

Velocity 308—innovation 315, merger & acquisition, turnaround and restructuring.

Risk 310—compliance 316, and bad and doubtful debts.

Each process is further defined by three categories that relate to financial objectives 317, strategic objectives 318 and operational objectives 319.

Each item in a process category 317, 318, 319 is linked to one or more metrics, for example a number (#), currency value and/or a percentage value. The metrics may be stored in the database 24, and may be sourced from an external source, for example a source specialising in business research metrics. There is no limit to the number of metrics that can be associated with each process category.

At least some of the items in a process category 317, 318, 319 are also linked to one or more graphical representations related to the process that are sourced from a library of graphical representations particular to the industry value map 44.

In the present example shown in FIG. 7, an item ‘fees per branch’ 320 is selected and branch fee metrics including personal loan fees, business loan fees and ATM fees are shown. Also shown are a 3D graphic 321 representative of a loan application and a 3D graphic 322 representative of an ATM Machine.

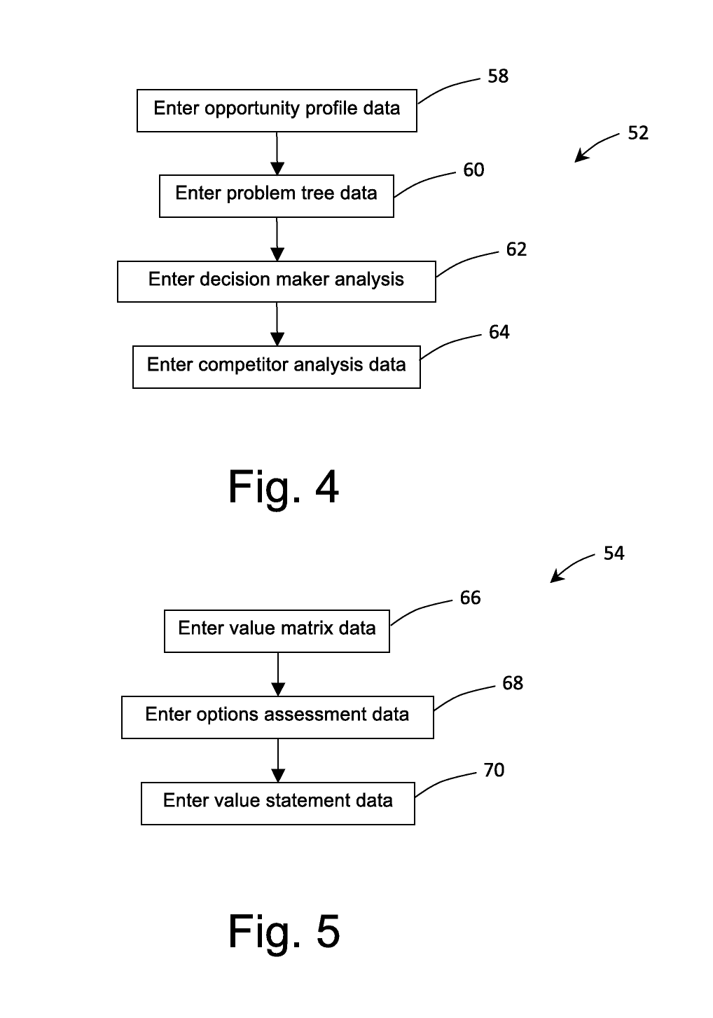

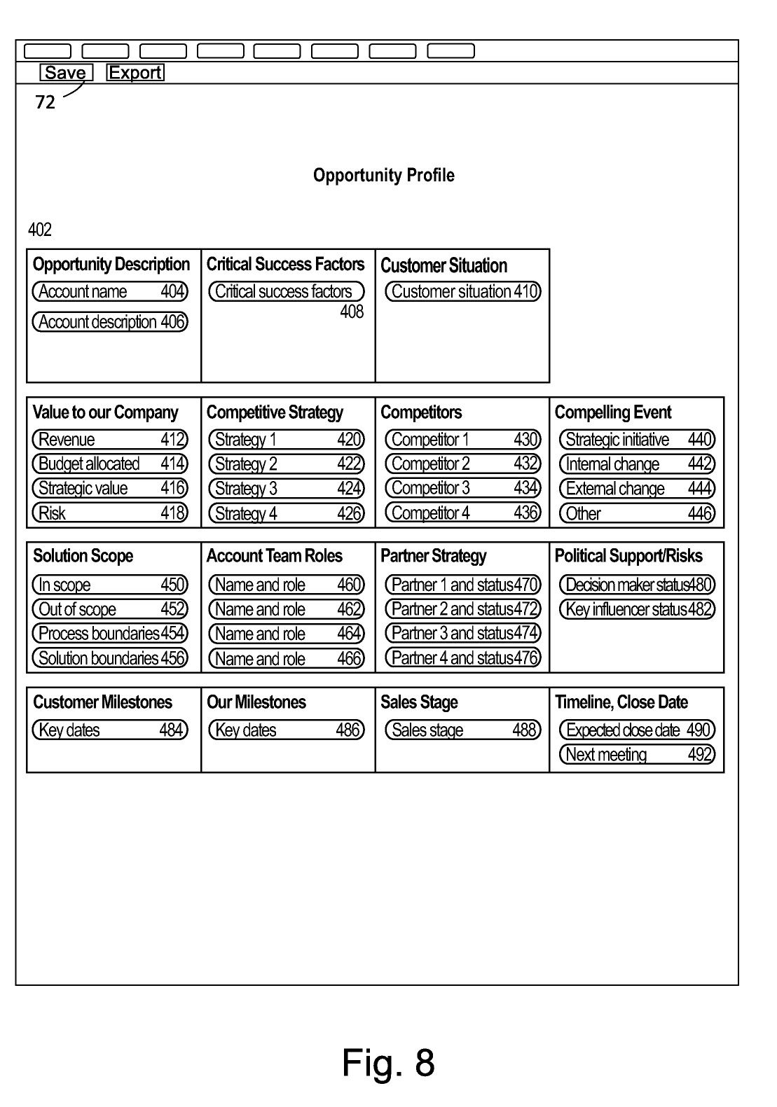

The analysis step 52 of the process 50 is shown in more detail in FIG. 4. The analysis step includes the sub-step of entering opportunity profile data 58, in this example using an opportunity profile screen 400 shown in FIG. 8. The opportunity profile data defines an overview of the scope of the problem that a client is perceived to have, and therefore an opportunity that the user may have if the user is able to offer a solution to the problem.

The opportunity profile is presented to the user as an editable document that accepts inputs in a number of fields. In this example, the fields include:

account name 404—a name for the problem to be solved;

account description 406 in the form of a short description of the problem to be solved, the client name and business unit name;

critical success factors 408—considerations affecting the ability of the user to solve the problem including:
differentiation—does the user have a unique value proposition?
political support—does the user have access to senior decision makers?
right resources—does the user have access to the right internal resources, such as industry expertise, solution architects, and relationship managers?
demonstrate ROI—can the user demonstrate return on investment (ROI) for the client or prospective client?
other interdependencies
timing—does the user have time to influence the decision criteria?; and
customer situation 410—details of the external or internal trends that are impacting the client;

The fields on the opportunity profile screen 400 also include fields related to the perceived value to the user:

revenue 412—the monetary amount that the client is expected to spend;

budget allocated 414—how much is the user prepared to spend to be given the opportunity to provide the client with the solution to the identified problem;

strategic value 416—the value to the user other than revenue that would make winning the business important, for example preventing a competitor from winning the business;

risk 418—the risks associated with winning or losing the business, for example whether the user is likely to gain or lose market share, ability to deliver, technical risks, strategic risks.

The fields on the opportunity profile screen 400 also include fields related to the competitive strategy to distinguish the product or service offering provided by the user from product or service offerings provided by competitors:

strategy1 420—the current or preferred strategy to deal with competitors who could also solve the identified problem (e.g. Frontal, Flank, Fragment, Defend, Develop); and

strategy2, strategy3, strategy 4 422, 424, 426—any concurrent or alternative strategies.

The fields on the opportunity profile screen 400 also include fields related to the competitors:

competitor1 430—the primary competitor who could also solve the client's problem; and

competitor2, competitor3, competitor4 432, 434, 436—other competitors who could also solve the problem.

The fields on the opportunity profile screen 400 also include fields for entering information related to a compelling event that may influence the client's decision to acquire the product or service from the user:

strategic initiative 440—is there a strategic customer initiative with which the solution offered by the user can align?;

internal change 442—has there been a change internally to make the identified problem a priority for the client?; and

external change 444—has there been a change externally to make the identified problem a priority for the client?

The fields on the opportunity profile screen 400 also include fields related to the scope of the solution:

in scope 450—in defining the solution to the client's problem, what is included? For example, if the identified client problem is profitability, is both revenue enhancement and cost reduction in scope?;

out of scope 452—in defining the solution to the customer's problem, what is excluded? For example, some parts of the problem may be out of scope for political or strategic reasons;

process boundaries 454—any process boundaries that assist scope definition; and

service boundaries 456—any service boundaries that assist scope definition.

The fields on the opportunity profile screen 400 also include fields that specify the team that will interact with the client, and the roles of the individuals in the team:

name and role 460, 462, 464, 466—name and role of people associated with the user that will work with the client to solve the problem.

The fields on the opportunity profile screen 400 also include fields that specify any partners that are proposed to be involved with providing the solution:

partner1, partner2, partner3, partner4 470, 472, 274, 276—name of the solution partners, the status of the user with them, and the engagement strategy.

The fields on the opportunity profile screen 400 also include fields that detail the political support and risks involved:

decision maker status 480—an indication of the level of access the user has to senior decision makers at the client; and

key influencer status 482—the user's knowledge about their status with the client's key influencers.

The fields on the opportunity profile screen 400 also include:

customer key dates 484—the important dates from the client's perspective;

our key dates 486—the important dates from the user's perspective;

sales stage 488—the current stage of the sales process;

expected close date 490—the expected agreement finalisation date if the client selects the user to solve the problem; and

next meeting 492—the next meeting date with the client.

After entering information in the respective fields on the opportunity profile screen 400, the information is saved to the database 24, for example by activating a save button 72.

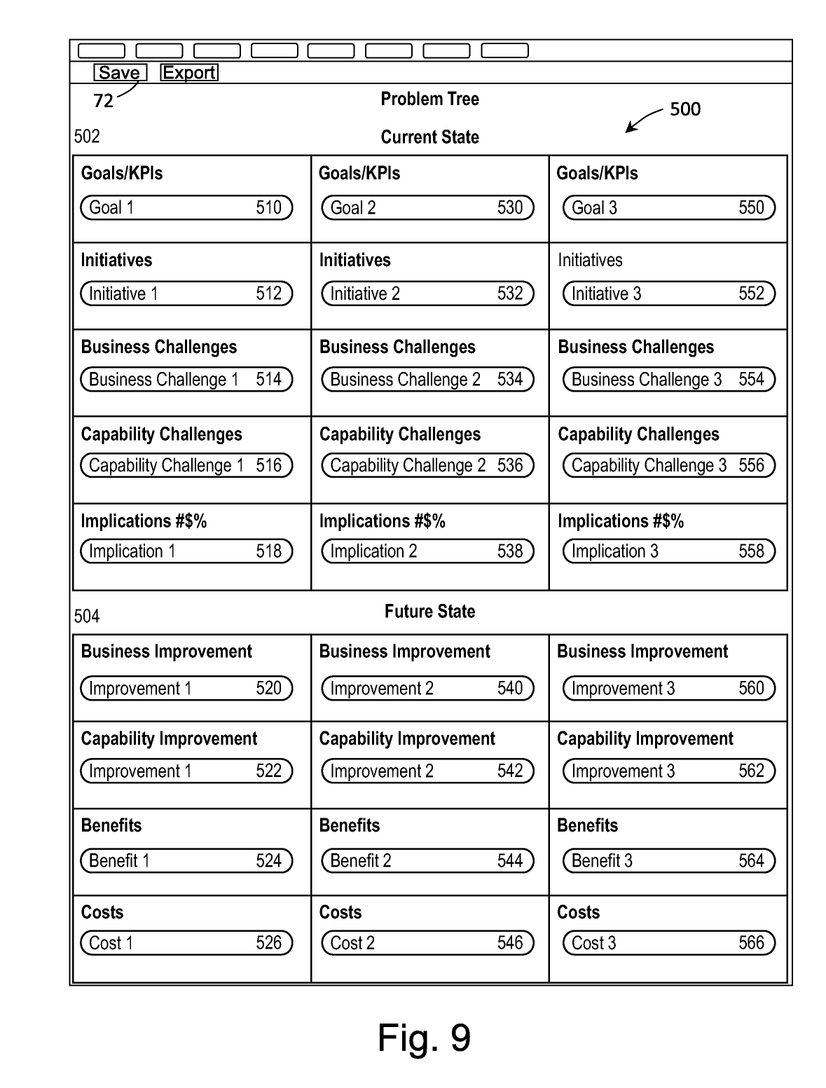

The analysis step 52 also includes the sub-step of entering problem tree data 60, in this example using a problem tree screen 500 shown in FIG. 9. The problem tree screen 500 includes a structured description of the problem to be solved in terms of the current business state of the client, and a description of the future state of the client after implementation of the proposed solution offered by the user.

The problem tree is presented to the user as an editable document that accepts input in a number of fields separated into a current state section 502 and a future state section 504.

In this embodiment, the fields in the current state section 502 include:

goal1, goal2, goal3 510, 530, 550—a goal can relate to any of the financial, strategic or operational process categories 317, 318, 319 drawn from the value map 44 related to the client's industry. The specified goal is defined as a change in quantifiable terms to an item in a financial, strategic or operational process category. The goal field is populated by selecting the relevant industry from a set of displayed options, and selection of an industry determines the industry value map 44 that will be used to define the goal. For example, if the selected industry is retail banking, then the industry value map 44 related to retail banking will be used and the goals associated with the industry value map 44 made available for selection.

The industry selection method may be a droplist, a menu, palette, dialogue box or any other means of displaying and facilitating selection of a set of options.

Selection of an industry causes a set of business process groups relevant to the selected industry and present on the relevant industry value map screen 300 to be displayed to the user, in this example revenue, cost, capital, velocity and risk, together with process categories for each business process group, in this example financial, strategic and operational categories.

Each category includes several items that the user can select. The user is also able to add new items to a category and such user created items are stored in the category as custom items available for subsequent use. When the user has selected one or more items from one or more categories, the selections flow through to one or more goal fields 519, 512, 550 in the current state section 502 of the problem tree screen 74.

The tool may be arranged to suggest items to the user for selection as a goal to be included on the problem tree screen, for example based on default items defined for the industry value map that correspond to the most likely goals. The default items may correspond to the most common KPIs for decision makers in the industry associated with the industry value map.

The fields on the current state section 502 also include initiative fields 512, 532, 552 for the respective goals 510, 530, 550 that detail the work, project or programme that the user believes the client has undertaken to achieve a relevant goal. For example, if the selected industry is a bank branch and the specified goal is to increase the fees per branch by 100%, the initiative may be to allocate more resources with a view to attracting more customers.

The fields on the current state section 502 also include business challenge fields 514, 534, 554 for the respective goals 510, 530, 550 that detail the business challenges the user believes the client is experiencing in achieving the defined goals and/or deploying the defined initiatives.

The fields on the current state section 502 also include capability challenge fields 516, 536, 556 for the respective goals 510, 530, 550 that detail capability challenges that the user believes limit the client's ability to achieve the defined goals. A capability challenge could be related to technology, service management or delivery capability. For example, if the specified goal is to increase fees per branch by 100%, a capability challenge may relate to the ability of staff to attract more customers or sell more services to increase fees per branch.

The fields on the current state section 502 also include implications fields 518, 538, 558 for the respective goals 510, 530, 550 that detail the user's belief in relation to the result of the client's current challenges to achieve the relevant goal. For example, if the current business and capability challenges are causing the client to only achieve 30% of the goal, then the implication is that the stated initiatives are causing a 70% reduction of the desired outcome in quantifiable terms (numbers, dollars or percent difference).

In this embodiment, the fields in the future state section 504 include business improvement fields 520, 540, 560 for the respective goals that detail the business improvements that the user believes could be made by the user to assist the client in achieving the stated goal.

The fields on the future state section 504 also include capability improvement fields 522, 542, 562 for the respective goals that detail the capability improvements that the user believes can be made by the user to assist the client in achieving the stated goals. The capability improvement could be related to technology, service management or delivery capability.

The fields on the future state section 504 also include benefits fields 524, 544, 564 for the respective goals that detail the benefit to the client that the user believes can be achieved by implementation of the improvements stated in the business improvement and capability improvement fields 520, 540, 560, 522, 542, 562.

The fields on the future state section 504 also include costs fields 526, 546, 566 for the respective goals that detail the expected cost to the customer for the user to deliver the improvements stated in the business improvement and capability improvement fields 520, 540, 560, 522, 542, 562.

After entering information in the respective fields on the problem tree screen 500, the information is saved to the database 24, for example by activating a save button 72.

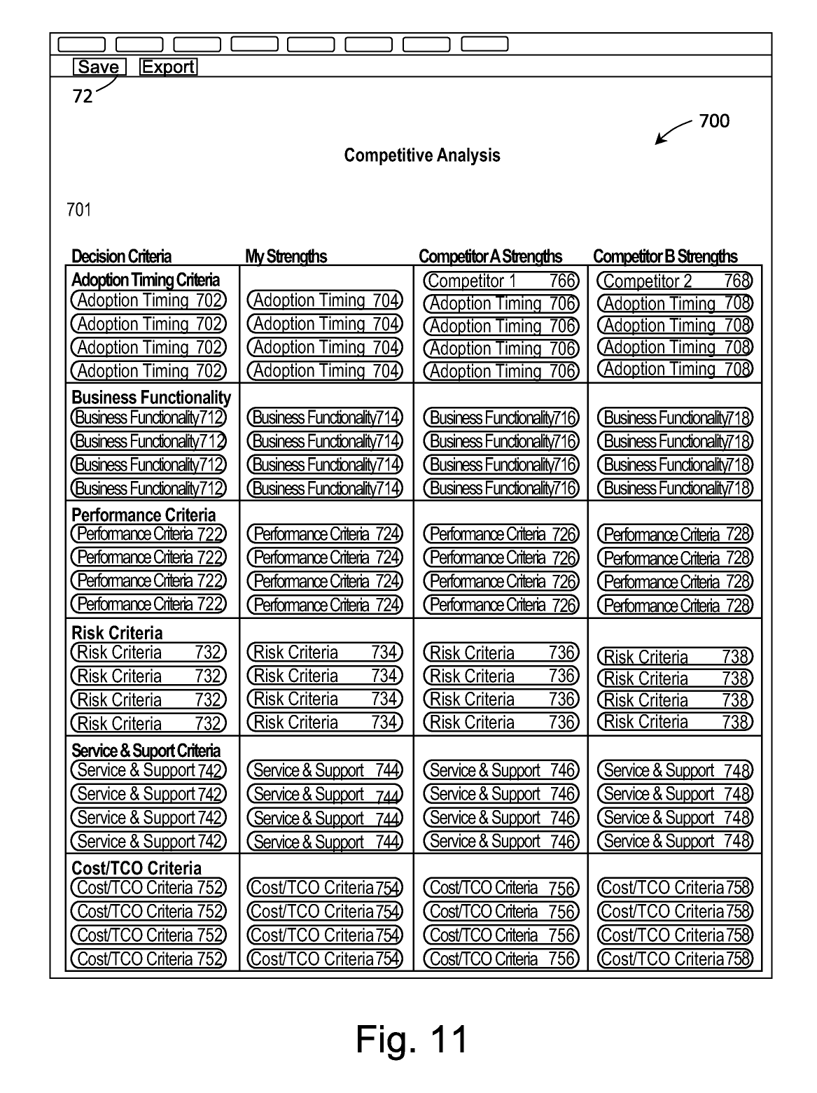

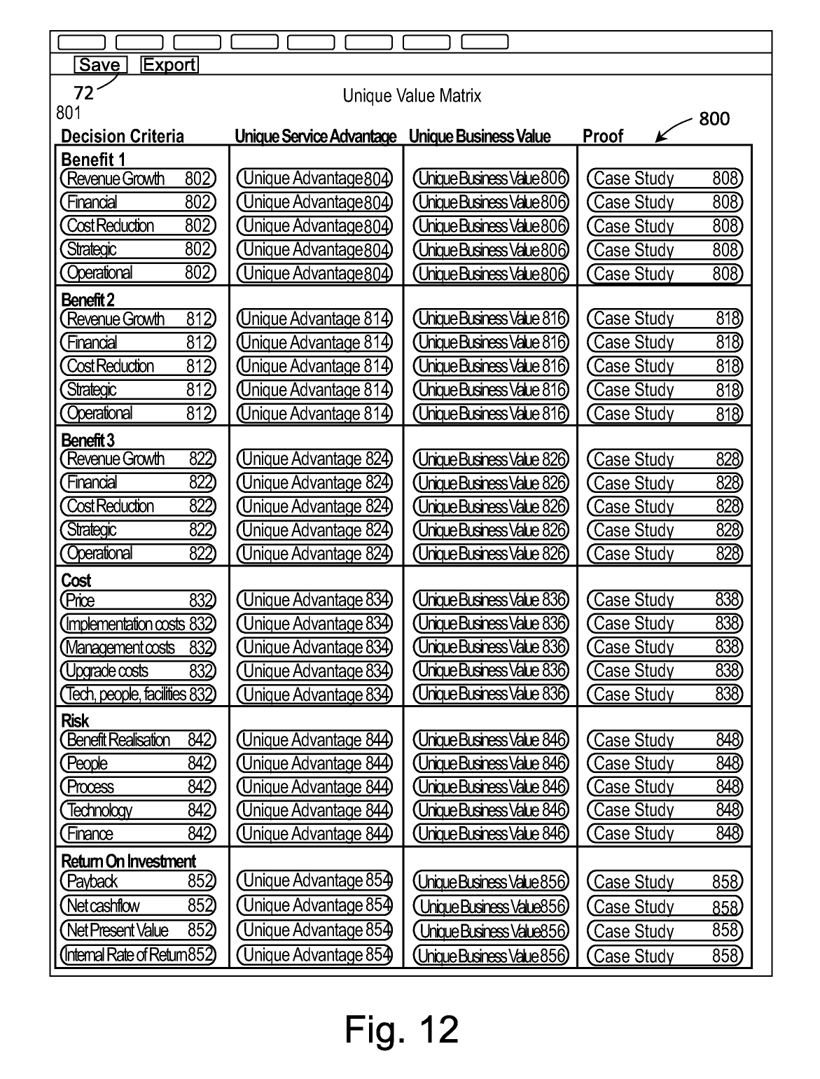

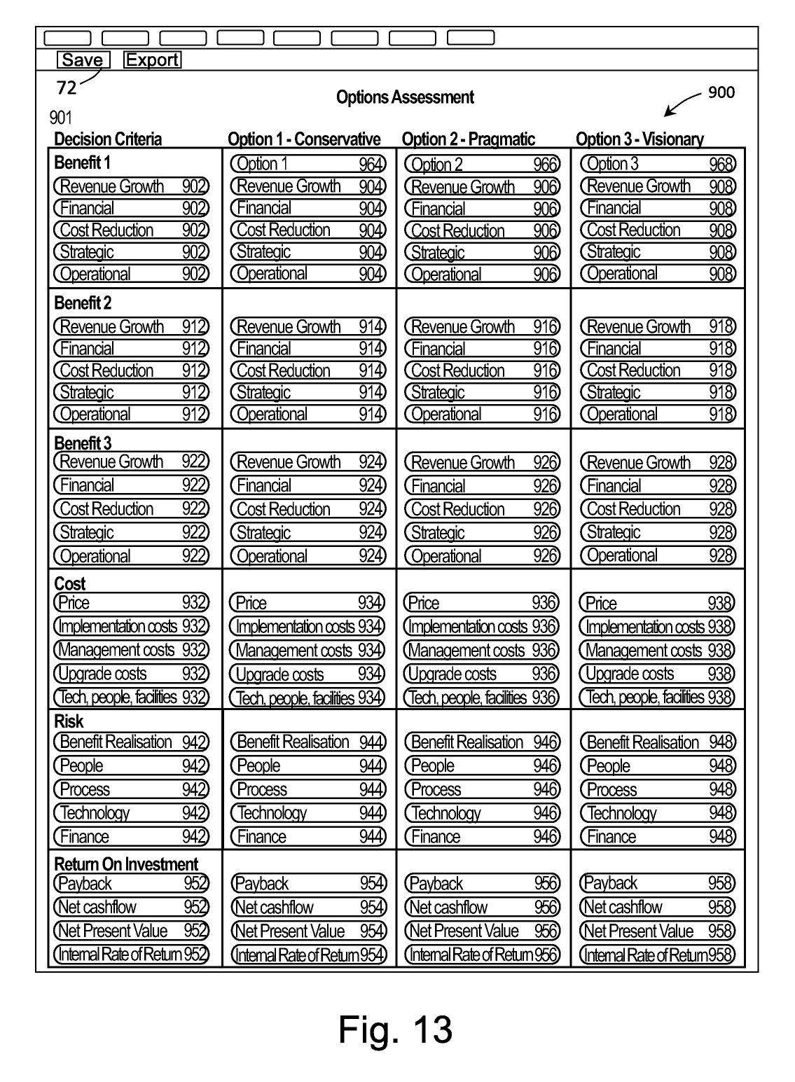

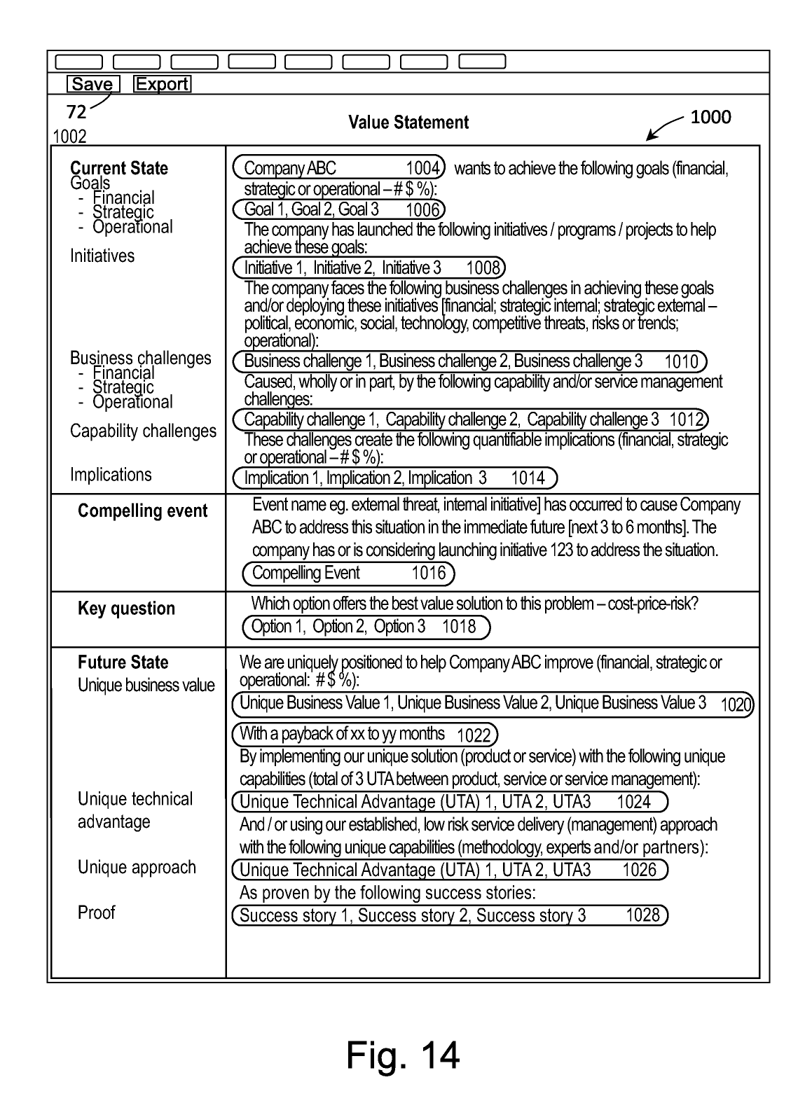

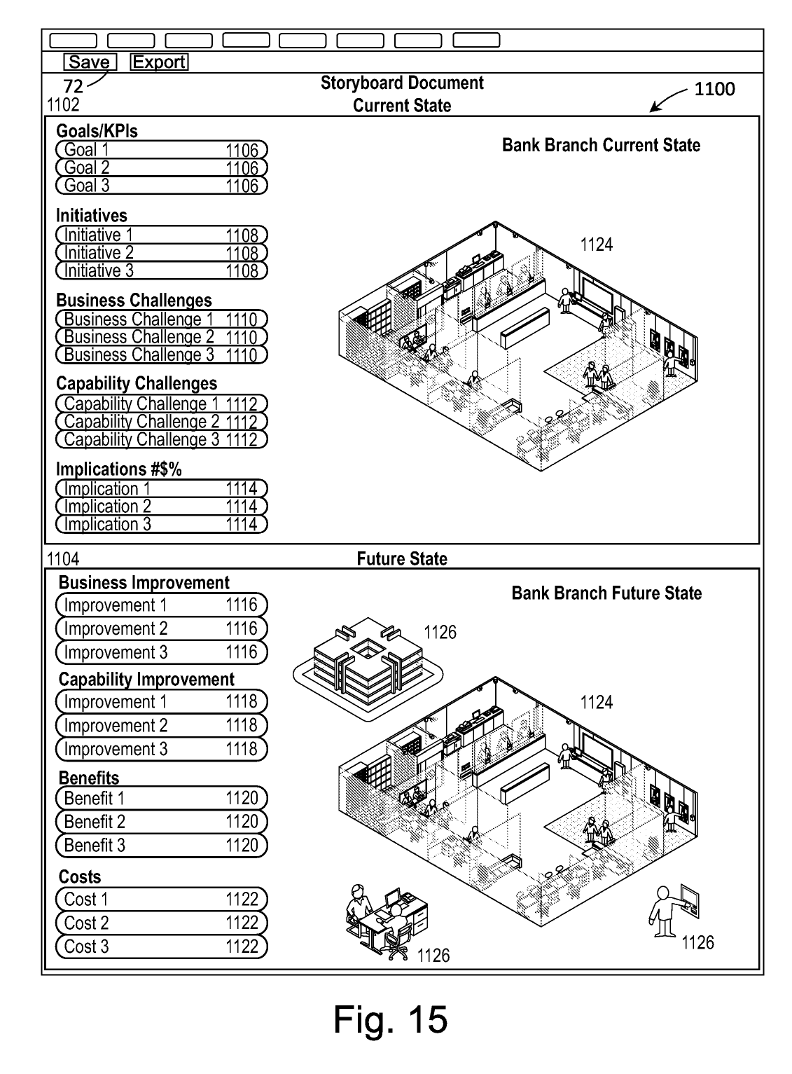

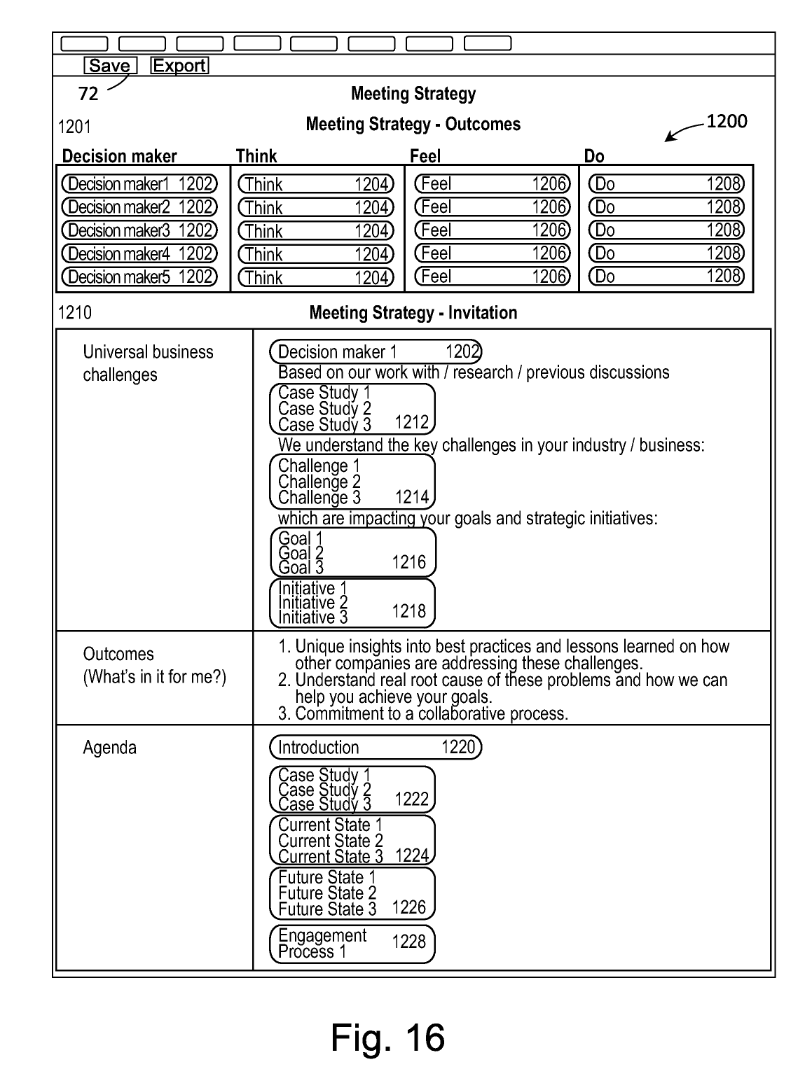

Some of the information is stored in the database for reference and some information is also carried forward into subsequent screens presented to a user during the process. In this example, the information in the goals fields 510, 530, 550, the initiatives fields 512, 532, 552, the business challenges fields 514, 534, 554, the capability challenges fields 516, 536, 556, the implications fields 518, 538, 558, the business improvement fields 520, 540, 560, the capability improvement fields 522, 542, 562, the benefits fields 524, 544,564 and the costs fields 526,546,566 flow through to other screens and to documents produced by the process tool 10, including:
the competitive analysis screen 700 shown in FIG. 11;
the unique value matrix screen 800 shown in FIG. 12;
the options assessment screen 900 shown in FIG. 13;
the value statement screen 1000 shown in FIG. 14;
the storyboard screen 1100 shown in FIG. 15 and subsequent printed storyboard document;
the meeting strategy screen 1200 shown in FIG. 16 and subsequent printed document; and
the script screen 1400 and subsequent printed script document.

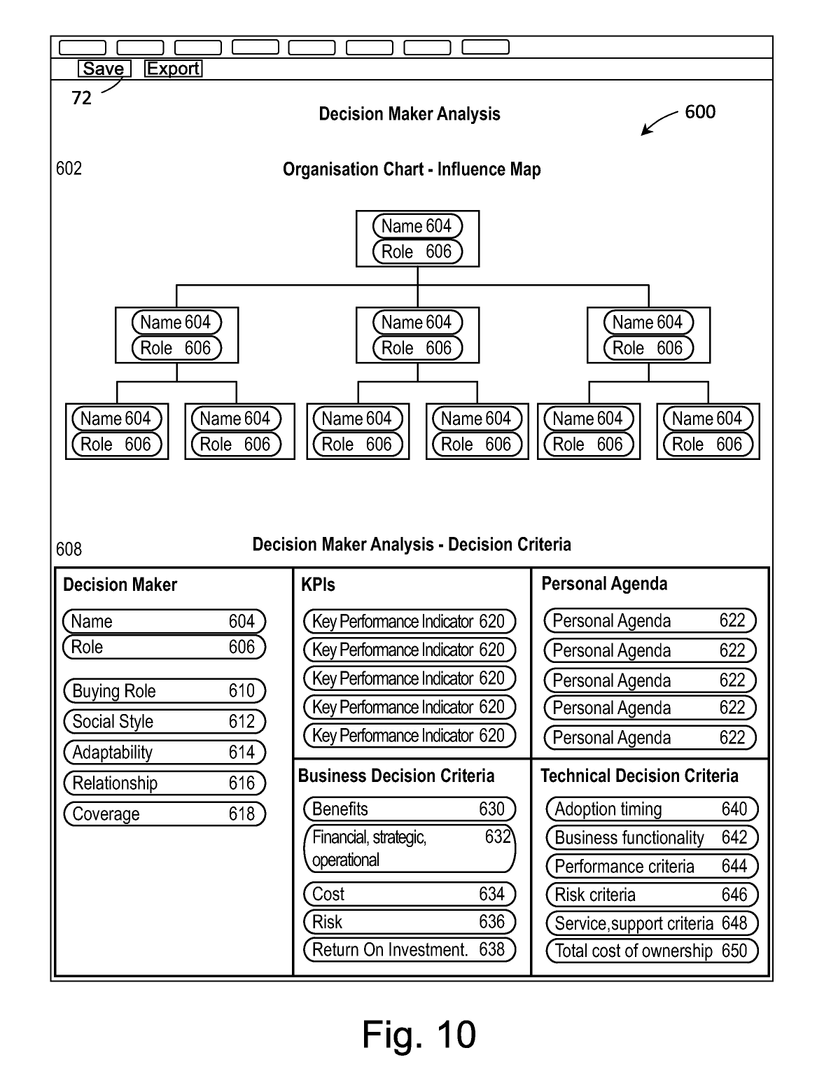

The analysis step 52 also includes the sub-step of entering decision maker analysis data 62, in this example using a decision maker analysis screen 600 shown in FIG. 10. The decision maker analysis screen 600 includes a structured representation of people associated with the client who have influence, authority or responsibility to solve the client's problem, that is, decision makers associated with the client.

The fields on the decision maker analysis screen 76 are grouped into 2 sections. An organisation chart 602 describes the names and roles of the people associated with the client who have influence, authority or responsibility to solve the problem. A decision maker analysis section 608 describes an individual decision maker in more detail, and selection of a decision maker in the organisation chart displays a decision maker analysis section for the selected decision maker.

The fields on the organisation chart 602 include the names 604 and associated roles 606 of decision makers that are believed to exist at the client, and the user completes the required fields to define a representation of the hierarchy at the client of decision makers and influencers that are likely to be responsible for solving the identified client problem.

The decision maker analysis section 608 includes fields used to document the user's best understanding of the decision criteria and any other factors likely to influence the decision maker in relation to the identified client problem and proposed solution. The decision maker fields include the following fields for each decision maker:

name 604—the name of the decision maker copied from the organisation chart 602;

role 606—the role of the decision maker 606 copied from the organisation chart 602; and

buying role 610—the categorisation of the type of role that the decision maker has in relation to purchasing of services and/or products. A person may be able to influence the outcome of a decision even if the person is not directly responsible for solving the problem. For example, a technical evaluator may review a proposed solution on purely technical merits and not consider the financial aspects of the solution. In order to effectively communicate the ability of a person to solve a problem, the buying role of each decision maker should be understood as it relates directly to their decision criteria and degree of influence. Buying roles include:
1. Approver—The person with authority to approve the proposed solution;
2. Decision maker—The person responsible for solving the problem;
3. Evaluator—The person who is capable of assessing if the solution is likely to solve the problem;
4. User—The person who will be implementing the solution for the client; and
5. Sponsor—The person with some authority at the client who believes the solution is likely to solve the problem.

The decision maker analysis section 608 also includes the following fields:

social style 612—an indication of the personality type of the decision maker perceived by the user. Every person's social style is different. There are four main social styles:
1. Expressive: Focus on people, makes statements, dislikes detail;
2. Amiable: Focus on people, asks questions, likes detail;
3. Analytical: Focus on tasks, asks questions, likes detail; and
4. Driver: Focus on tasks, makes statements, dislikes detail.

adaptability 614—an indication of the perceived adaptability of the decision maker. Adaptability is a measurement of a person's willingness to embrace new things. If a conservative person has to decide between a radical solution to a problem and a conservative solution, the person will generally choose the conservative solution. There are five adaptability types:
1. Innovator: Enthusiast who loves exploring new solutions;
2. Visionary: Early adopter who quickly sees the advantage of a new solution;
3. Pragmatist: Middle adopter of a new solution;
4. Conservative: Late adopter of a new solution; and
5. Laggard: Actively resists anything new.

relationship 616—the relationship status of the user to the decision maker. There are five options to select that categorise the relationship type:
1. Enemy: Decision maker will actively try to prevent users solution being approved;
2. Non Supporter: Decision maker will not support users solution being approved;
3. Neutral: Decision maker has no preference;
4. Supporter: Decision maker will support users solution being approved; and
5. Mentor: Decision maker will actively promote users solution to be approved.

coverage 618—the amount of contact the user has had with the decision maker. The information in this field provides an indication of the level of understanding that the user has of the decision maker and the quality of their relationship. There are four options to select for coverage:
1. None: No contact. Decision maker is a stranger;
2. Brief: Some contact. Decision maker is largely unknown;
3. Multiple: Good contact. Decision maker is well known; and
4. In Depth: Very good contact. Decision maker is very well known.

The decision maker analysis section 608 also includes fields relating to key performance indicators 620 that are believed by the user to correspond to the decision maker's 5 most important measurable KPIs, for example in the form of goals, objectives, strategic initiatives or projects. In one example, the KPIs 620 are extracted from the relevant industry value map 44 associated with the decision makers industry and relevant financial, strategic or operational business driver.

The decision maker analysis section 608 also includes the following fields:

personal agenda 622—the perception as to the decision maker's personal agenda, for example in terms of career success, significance and/or job security;

business decision criteria including benefits 630; financial, strategic, operational drivers 632; cost 634; risk 636; and return on investment 638. These fields correspond to the 5 most important business decision criteria that the user perceives are relevant to the decision maker for the identified problem;

technical decision criteria that correspond to the 5 most important technical solution criteria that the user perceives are relevant to the decision maker for the identified problem. In this example, the technical solution decision fields include:

adoption timing 640—the key criteria that are believed to drive the client's thinking on deployment phases and timing, for example competitive advantage, business imperatives, capital availability or price-performance curve;

business functionality 642—the product or service features and functions that are believed by the user to be critical to driving improvement in business results at the client;

performance criteria 644—the key performance criteria and service levels that the user believes the solution must achieve in order to solve the business problem for the client, for example capacity, availability, response time, quality and/or reliability;

risk criteria 646—the key risks and the key features and functions required to mitigate those risks that are perceived by the user to exist for the client, for example security, disaster recovery, and transition risk in terms of technology, process, people, financial and/or facilities;

service and support criteria 648—the services, features and functions that the user believes are required by the client in order to solve the identified problem. Considerations include client capability gaps in planning, design, implementation, maintenance, change management, technical support; and

cost/total cost of ownership 650—the key investment decision criteria that the user believes are relevant to the client, for example price, life cycle costs (acquisition, management, upgrade costs), and/or resource costs (technology, people, facilities, services, materials).

After entering information in the respective fields on the decision maker analysis screen 76, the information is saved to the database 24, for example by activating a save button 72.

Some of the information is stored for reference in the document and at least some information is carried forward into subsequent documents in the process. For example, business decision criteria fields 630-638 and technical decision criteria 640-650 flow through to other screens and to documents produced by the process tool 10, including:
the competitive analysis screen 700 shown in FIG. 11;
the unique value matrix screen 800 shown in FIG. 12; and
the options assessment screen 900 shown in FIG. 13.

The analysis step 52 also includes the sub-step of entering competitive analysis data 64, in this example using a competitive analysis screen 700 shown in FIG. 11. The competitive analysis screen 700 includes a structured comparison of the user's strengths with the strengths of two main competitors specified in the opportunity profile screen 400 shown in FIG. 8.

The fields on the competitive analysis screen 700 under the heading Decision Criteria are populated with data entered on previous screens including information entered in the following fields: adoption timing 702, business functionality 712, performance criteria 722, risk criteria 732, service & support 742 and cost/total cost of ownership 752. The information in the competitor 1 766 and competitor 2 768 fields is copied from the competitor 1 430 and competitor 2 432 fields on the opportunity profile screen 400 shown in FIG. 8. Additional columns can be added to analyse more competitors as required.

The competitive analysis screen 700 also includes under columns My Strengths, Competitor A Strengths and Competitor B Strengths fields 704, 706, 708, 714, 716, 718, 724, 726, 728, 734, 736, 738, 744, 746, 748, 754, 756 and 758 corresponding to adoption timing 702, business functionality 712, performance criteria 722, risk criteria 732, service & support 742 and cost/total cost of ownership 752 fields. In these fields, the user enters information based on the user of the strengths of the user and the strengths of the primary competitors.

After entering information in the respective fields on the competitive analysis screen 700, the information is saved to the database 24, for example by activating a save button 72.

The strategy step 54 of the process 50 is shown in more detail in FIG. 5. The strategy step 54 includes the sub-step of entering value matrix data 66, in this example using a unique value matrix screen 800 shown in FIG. 12.

The unique value matrix screen 800 provides information as to the unique service advantage of the user in fields 804, 814, 824, 834, 844 and 854, the unique business value provided by the user in fields 806, 816, 826, 836, 846 and 856, and proof of the service and business advantages in fields 808, 818, 828, 838, 848 and 858. These fields relate to business decision criteria in fields 802, 812, 822, 832, 842 and 852 derived from fields 630, 632, 634, 636 and 638 of the business decision criteria identified in the decision maker analysis screen 600.

Based on the information on the decision maker analysis screen 600, the user identifies the key business decision criteria that are believed to be important to the client, in this example:

benefits 800 to 822—the quantifiable financial benefits the solution provided by the user will deliver;

cost 832—the key cost criteria identified by the client;

risk 842—the key risk issues the client has raised; and

return on investment 852—the client's key business case metrics.

The user reviews the information entered into the competitive analysis screen 700, identifies the key features of the solution proposed by the user that meet or exceed the business decision criteria more effectively than any of the main competitors, and enters the identified key features into the fields 804, 814, 824, 834, 844 854 under the heading Unique Service Advantage. The user then formulates a strategy for influencing the decision criteria to meet the user's unique technical advantage.

The user then identifies the specific business drivers in relation to which the user can outperform the main competitors, and enters this information into the fields 806, 816, 826, 836, 846 and 856 under heading Unique Business Value.

Under the column heading Proof, the user identifies sources of evidence to prove the statements made in the fields under the headings Unique Service Advantage and Unique Business Value. Such proof may include for example demonstrations, case studies, customer references and/or resource costs.

After entering information in the respective fields on the unique value matrix screen 800, the information is saved to the database 24, for example by activating a save button 72.

The strategy step 54 also includes the sub-step of entering options assessment data 68, in this example using an options assessment screen 900 shown in FIG. 13.

The options assessment screen 900 contains a structured comparison between high, medium and low cost options to suit the user's understanding of client adaptability specified in the adaptability field 614 on the decision maker analysis screen 600 in FIG. 10, and also in response to the user's estimate of the most likely solution and cost to be offered by competitors.

The information in the decision criteria fields benefit 1 902, benefit 2 912, benefit 3 922, cost 932, risk 942, return on investment 952 is copied from the fields 802, 812, 822, 832, 842, 852 in the unique value matrix screen 800 shown in FIG. 12.

Under the column headed “Option 1—Conservative”, the user enters the required decision criteria information to describe a low cost, narrow scope, conservative solution to the client's problem according to the decision criteria fields 902, 912, 922, 932, 942 and 952.

Under the column headed “Option 2—Pragmatic”, the user enters the required decision criteria information to describe a mid cost, medium scope, pragmatic solution to the client's problem according to the decision criteria fields 902, 912, 922, 932, 942 and 952.

Under the column headed “Option 3—Visionary”, the user enters the required decision criteria information to describe a higher cost, wide scope, visionary solution to the customer's problem according to the decision criteria fields 902, 912, 922, 932, 942 and 952.

The options assessment screen 900 is used to evaluate ‘what-if’ scenarios that match the client decision makers and their personality—visionary, pragmatist or conservative.

During the strategy steps 54, the user considers what the competition may be offering, and develops a solution that covers personality types, and develops two options that span the client's and the competitor's widest and narrowest requirements in relation to price, risk and value.

During the strategy steps 54, the user also develops test options to:
Assess the pros and cons of each option;
Assess how well each option delivers against the client's decision criteria;
Assess each option against the competitor's offerings; and
Assess each option with the client.

It will be understood that the user enters information into the fields on the options assessment screen 900 based on the user's understanding of the information on the unique value matrix screen 800.

After entering information in the respective fields on the options assessment screen 900, the information is saved to the database 24, for example by activating a save button 72.

The user then reviews the problem tree screen 500 shown in FIG. 9 and updates the information on the problem tree screen 500 in consideration of any new information arising from the completion of the decision maker analysis screen 600, the competitive analysis screen 700, the unique value matrix screen 800 and the options assessment screen 900.

The strategy step 54 also includes a step of entering value statement data 70, in this example using a value statement screen 1000 shown in FIG. 14.

The value statement screen 1000 contains on a single screen information that describes the client's problem as defined on the opportunity profile screen 400 and the problem tree screen 500, and the solution described on the unique value matrix screen 800, with options drawn from the options assessment screen 900. The value statement screen 1000 shows how the user's strengths will address the client's problems in unique ways that the competition can't match.

Some fields on the value statement screen 1000 are populated with data from other screens, including:

account name 1004—copied from account name 404 on the opportunity profile screen 400 shown in FIG. 8;

goal 1, goal 2, goal 3 fields 1006—copied from goal 1, goal 2, goal 3 fields 510, 530, 550 on the problem tree screen 500 shown in FIG. 9;

initiative 1, initiative 2, initiative 3 fields 1008—copied from initiative 1, initiative 2, initiative 3 fields 512, 532, 552 on the problem tree screen 500 shown in FIG. 9;

business challenge 1, business Challenge 2, business challenge 3 fields 1010—copied from business challenge 1, business challenge 2, business challenge 3 fields 514, 534, 554 on the problem tree screen 500 shown in FIG. 9;

capability challenge 1, capability challenge 2, capability challenge 3 fields 1012—copied from initiative 1, initiative 2, initiative 3 fields 516, 536, 556 on the problem tree screen 500 shown in FIG. 9;

implication 1, implication 2, implication 3 fields 1014—copied from implication 1, implication 2, implication 3 fields 518, 538, 558 on the problem tree screen 500 shown in FIG. 9;

compelling event 1016—copied from compelling events 440, 442, 444, 446 fields on the opportunity profile screen 400 in FIG. 8;

option 1, option 2, option 3 fields 1018—copied from option 1, option 2, option 3 fields 964, 966, 968 on the options assessment screen 900;

unique business improvement 1, unique business improvement 2, unique business improvement 3 fields 1020—copied from business improvement 1, business improvement 2, business improvement 3 fields 520, 540, 560 on the problem tree screen 500 shown in FIG. 9;

unique capability advantage 1, unique capability advantage 2, unique capability advantage 3 fields 1022—copied from capability improvement 1, capability improvement 2, capability improvement 3 fields 522, 542, 562 on the problem tree screen 500 shown in FIG. 9;

unique service advantage 1, unique service advantage 2, unique service advantage 3 fields 1024—copied from the service & support fields 742 on the competitive analysis screen 700 shown in FIG. 11; and

success story 1, success story 2, success story 3 fields 1028—copied from case study fields 808, 818, 828, 838, 848, 858 on the unique value matrix screen shown in FIG. 12.

After entering information in the respective fields on the value statement screen 1000, the information is saved to the database 24, for example by activating a save button 72.

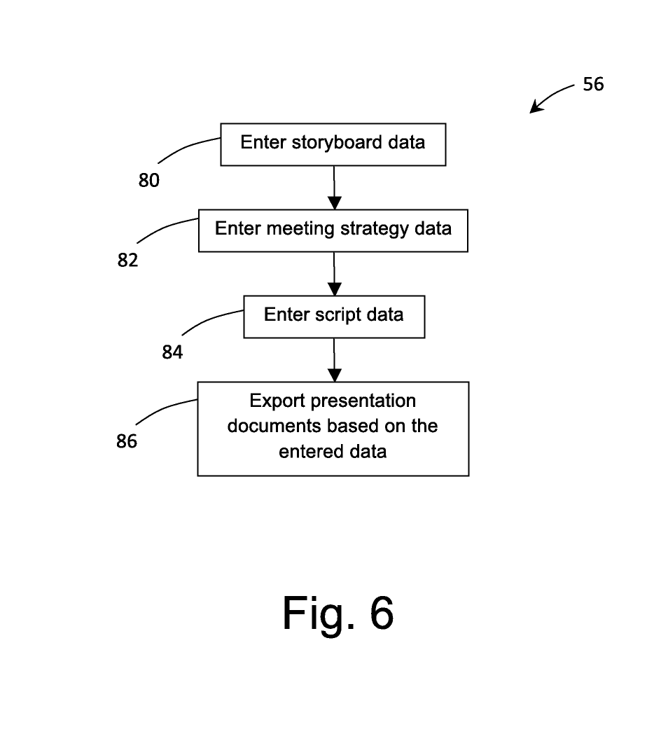

The materials production step 56 of the process 50 is shown in more detail in FIG. 6. The materials production step 56 includes the sub-step of entering storyboard data 80, in this example using a storyboard document screen 1100 shown in FIG. 15.

The storyboard document screen 1100 shows a current state representation 1102 and a future state representation 1104 of a business problem. The storyboard document screen 1100 includes editable text fields, and graphical representations that are editable by addition and/or removal 2D and 3D graphics from a library of 3D graphical representations associated with the selected industry value map 44.

Some fields of the storyboard document screen 1100 are populated with data from other screens. For example, in this embodiment information in goals/KPI, initiatives, business challenges, capability challenges, implications, business improvement, capability improvement, benefits, and costs fields 1106, 1108, 1110, 1112, 1114, 1116, 1118, 1120, 1122 of the storyboard document screen 1100 are copied from the respective fields 506, 508, 510, 512, 514, 516, 518, 520, 522 of the problem tree screen 500.

The user has the option to select which 3D graphical representations from a defined library of graphical representations related to the industry concerned will be displayed on the storyboard document screen 1100.

The selection method could be a droplist, a menu, palette, dialogue box or any other means of displaying a set of options, all of which are familiar to those skilled in the art.

The user also has the option to choose from a number of templates appropriate to the problem being described. For example, for a problem that is constrained to one physical location (e.g. a bank branch) the user might choose a template that has one large bank branch 3D Graphic in the centre of the available page space. For a problem relating to a linear process like manufacturing, the user might choose a template that is displayed as a flow chart and select a number of 3D Graphics related to the manufacturing process referred to in the industry value map 300. The number and design of the templates is not constrained to the examples above and the user has access to as many templates as are required.

The user has the option of saving the storyboard document screen 1100 and exporting the storyboard document screen 1100 as an electronic document that can be used as part of a visual presentation in a meeting with the client during which the proposed solution to the identified client problem will be discussed. The information on the storyboard document screen 1100 may be exported using an export button 74.

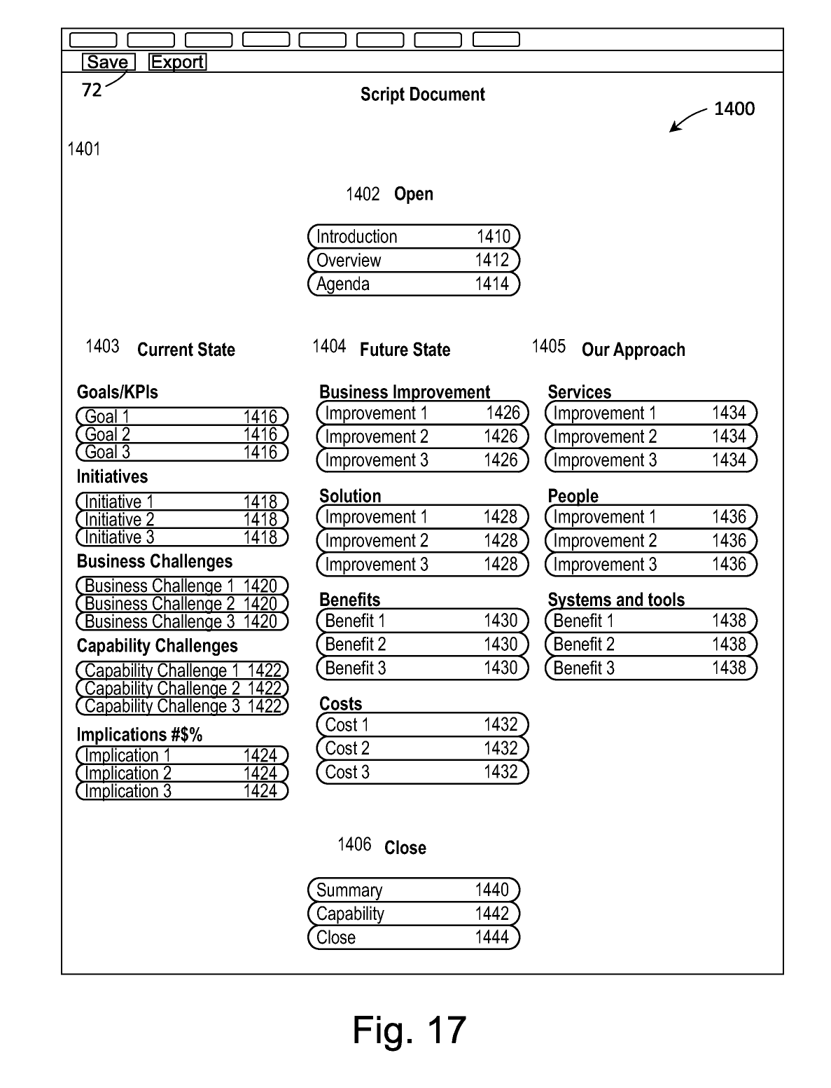

The materials production step 56 also includes the sub-step of entering meeting strategy data 82 usable to generate a meeting strategy document for use at a meeting with the client, for example using a meeting strategy screen 1200 shown in FIG. 16, and the sub-step of entering script data 84 usable to generate a meeting script document for use at the meeting, for example using a meeting script screen 1300 shown in FIG. 17.

The meeting strategy screen 1200 is used to define the outcomes a user would like to achieve from a meeting with decision makers associated with the client during which the proposed solution to the identified client problem will be discussed.

The meeting strategy screen 1200 includes an outcomes section 1201 and an invitation section 1210.

The outcomes section 1201 describes the desired result for each decision maker attending the meeting. Some fields are populated with data from previous screens. For example, the information in decision maker 1, decision maker 2, decision maker 3, decision maker 4 and decision maker 5 fields 1202 are copied from the name fields 604 on the decision maker analysis screen 600. The user has the option to add or remove decision makers depending on who is actually attending the meeting, and to updates the remaining fields for each attendee as appropriate. The remaining fields of the outcomes section include:

think 1204—what the user believes the decision maker should think as a result of the meeting;

feel 1206—what the user believes the decision maker should feel as a result of the meeting; and

do 1208—what the user believes the decision maker should do as a result of the meeting.

After defining the desired outcomes from the meeting for each decision maker, the user has the option for the system to generate a template meeting invitation and agenda.

The invitation section 1210 includes information populated from other screens and from the outcomes section 1201 of the meeting strategy screen 1200, including:

decision maker1 1202—copied from the decision maker1 field 1202 of the outcomes section 1201;

case study 1, case study 2, case study 3 1212—copied from success story 1, success story 2, success story 3 fields 1028 on the value statement screen 1000;

challenge 1, challenge 2, challenge 3 1214—copied from business challenge 1, business challenge 2, business challenge 3 on the value statement screen 1000;

goal 1, goal 2, goal 3 1216—copied from the fields goal 1, goal 2, goal 3 1006 on the value statement 1000;

initiative 1, initiative 2, initiative 3 1218—copied from the fields initiative 1, initiative 2, initiative 3 on the value statement screen 1000;

introduction 1220—copied from the field decision maker1 field 1202 of the outcomes section 1201;

case study 1, case study 2, case study 3 1222—copied from the fields success story 1, success story 2, success story 3 1028 on the value statement screen 1000;

current state 1, current state 2, current state 3 1224—summarised by the user from fields on the value statement screen 1000;

future state 1, future state 2, future state 3 1226—summarised by the user from fields on the value statement screen 1000; and

engagement process 1228—summarised by the user from fields on the value statement screen 1000.

Once the user has entered the appropriate information in the respective fields, the information can be saved and/or exported to an electronic document to be used as the basis for a meeting invitation.

The meeting script screen 1400 defines the sequence of information to be covered in the meeting with the decision makers.

The meeting sequence in this example includes 5 stages.

An open stage 1402 includes:

introduction 1410—universal challenges are summarised by the user from the business challenge fields 1010 and capability challenge fields 1012 on the value statement screen 1000 shown in FIG. 14;

overview 1412—the user lists the key 3 to 5 ideas to be discussed at the meeting in a way that manages potential objections; and

agenda 1414—the user defines the structure of the meeting according to the 5 stages.

A current state stage 1403 includes information summarised from the current state field 502 on the problem tree screen 500 shown in FIG. 9. For example:

goals/KPIs 1416—goal 1, goal 2, goal 3 summarised by the user from Goals/KPI fields 510, 530, 550 on the problem tree screen 500;

initiatives 1418—initiative 1, initiative 2, initiative 3 summarised by the user from initiative fields 512, 532, 552 on the problem tree screen 500;

business challenge 1420—business challenge 1, business challenge 2, business challenge 3 summarised by the user from business challenge fields 514, 534, 554 from on the problem tree screen 500;

capability challenge 1422—capability challenge 1, capability challenge 2, capability challenge 3 summarised by the user from implications fields 516, 536, 556 on the problem tree screen 500; and

implications 1424—implication 1, implication 2, implication 3 summarised by the user from capability challenge fields 518, 538, 558 on the problem tree screen 500.

A future state stage 1404 includes:

business improvement 1426—improvement 1, improvement 2, improvement 3 summarised by the user from business improvement fields 520, 540, 560 on the problem tree screen 500;

solution 1428—improvement 1, improvement 2, improvement 3 summarised by the user from capability improvement fields 522, 542, 562 on the problem tree screen 500;

benefits 1430—benefit 1, benefit 2, benefit 3 summarised by the user from benefits fields 524, 544, 564 on the problem tree screen 500; and

cost 1432—cost 1, cost 2, cost 3 summarised by the user from cost fields 526, 546, 566 on the problem tree screen 500.

An our approach stage 1405 includes:

services 1434—improvement 1, improvement 2, improvement 3 expanded by the user from capability improvement fields 522, 542, 562 on the problem tree screen 500;

people 1436—improvement 1, improvement 2, improvement 3 expanded by the user from capability improvement fields 522, 542, 562 on the problem tree screen 500; and

system and tools 1438—benefit 1, benefit 2, benefit 3 expanded by the user from capability improvement fields 522, 542, 562 on the problem tree screen 500.

A close stage 1406 includes:

summary 1440—user restates the information in the overview field 1412 to confirm coverage and potential resolution of customers problem.

capability 1442—summarised by the user from the services 1434, solution 1428, and benefits 1430 fields; and

close 1444—user asks for commitment (to resources, preference) to enable user to proceed to solve the client's problem.

Once the user has entered the appropriate information in the respective fields, the information can be saved and/or exported to an electronic document to be used as the basis for a meeting invitation.

Modifications and variations as would be apparent to a skilled addressee are deemed to be within the scope of the present invention.

1. A process tool comprising:
a data input application implemented by a computing device, the data input application arranged to facilitate definition of business process information by a user;
a plurality of user selectable industry value maps, each industry value map defining a library of metric information and graphical representations relevant to a particular industry;
the process tool being arranged to facilitate selection using the computing device of an industry value map by a user and to use information and graphical representations associated with the industry value map to define a framework to support a business conversation; and
the tool being arranged to produce materials using the business process information defined by the user according to the framework at least partly populated using the industry value map.

2. A process tool as claimed in claim 1, wherein the data input application is arranged to facilitate definition of the business process information by facilitating entry using the computing device of information by a user and/or selection of information by the user from pre-defined selection menus.

3. A process tool as claimed in claim 1, wherein the data input application is arranged to facilitate definition of the business process information by facilitating definition using the computing device of the business process information in a plurality of data entry stages.

4. A process tool as claimed in claim 3, wherein the tool is arranged to copy at least some information entered at a data entry stage to at least one other data entry stage.

5. A process tool as claimed in claim 3, wherein each data entry stage is associated with a data entry screen presented to the user by the computing device.

6. A process tool as claimed in claim 1, wherein the data input application is arranged to facilitate definition by a user using the computing device of a business opportunity that is perceived to exist for a user in relation to a client.

7. A process tool as claimed in claim 6, wherein the data input application is arranged to facilitate definition using the computing device of a strategy to be used by the user to present the business opportunity to the client.

8. A process tool as claimed in claim 7, wherein the process tool is arranged to facilitate generation of a strategy document, a storyboard document and/or a script document usable to guide the user in a business conversation with the client during which the business opportunity is presented to the client.

9. A process tool as claimed in claim 1, wherein each industry value map includes information structured according to a plurality of business process groups, each business process group having at least one associated business process, each business process separated into financial, strategic and operational process categories, and each process category including at least one item linked to at least one business metric.

10. A process tool as claimed in claim 9, wherein the business metric is a number, currency value and/or a percentage value.

11. A process tool as claimed in claim 9, wherein the process tool is arranged to facilitate entry using the computing device of items in each process category by a user.

12. A process tool as claimed in claim 9, wherein the items in each process category correspond to stored default values.

13. A process tool as claimed in claim 1, wherein the items in each process category are obtained from a remote source.

14. A process tool as claimed in claim 1, wherein the data input application is arranged to facilitate definition using the computing device of a problem that the client is perceived to have, the difficulties that the client is experiencing overcoming the problem, and the benefit believed to exist for the user in providing a solution to the client's problem.

15. A process tool as claimed in claim 14, wherein the data input application is arranged to facilitate definition using the computing device of current state information indicative of the client prior to implementing a solution to the problem, and future state information indicative of the expected state of the client after implementation of the solution proposed by the user.

16. A process tool as claimed in claim 15, wherein the data input application is arranged to facilitate definition using the computing device of a problem by facilitating selection of a goal using the selected industry value map, the goal being indicative of a desired change in quantifiable terms to an item in the selected industry value map.

17. A process tool as claimed in claim 16, wherein the tool is arranged to present suggested goals to the user.

18. A process tool as claimed in claim 17, wherein the suggested goals presented to the user are based on the most common goals for the industry associated with the industry value map.

19. A process tool as claimed in claim 16, wherein the future state information includes information indicative of the business and/or capability improvements proposed by the user to assist the client in achieving the selected goal.

20. A process tool as claimed in claim 19, wherein the future state information includes information indicative of the benefits that the user believes the client will receive by implementation of the proposed business and/or capability improvements.

21. A process tool as claimed in claim 1, wherein the data input application is arranged to facilitate entry using the computing device of information indicative of decision makers associated with the client that are likely to be involved with solving the identified problem.

22. A process tool as claimed in claim 1, wherein the data input application is arranged to facilitate definition using the computing device of relative strengths of the user and at least one competitor.

23. A process tool as claimed in claim 1, wherein the data input application is arranged to facilitate definition using the computing device of a plurality of proposed solutions to the identified client problem.

24. A process tool as claimed in claim 23, wherein the plurality of proposed solutions correspond to low, medium and high cost solutions.

25. A process tool as claimed in claim 23, wherein the plurality of proposed solutions correspond to conservative, pragmatic or visionary approaches to solving the identified client problem.

26. A process tool as claimed in claim 14, wherein the tool is arranged to produce a value statement indicative of the identified client problem, one or more solutions to the problem proposed by the user, and information indicative of the user's suitability to provide the solution.

27. A process tool as claimed in claim 1, wherein the data input application is arranged to facilitate definition using the computing device of storyboard information including information indicative of a current state of a client before implementation of the proposed solution to the identified client problem, and a future state of the client after implementation of the proposed solution, each of the current and future state information including at least one graphical representation of a business process item derived from the selected industry value map.

28. A process tool as claimed in claim 27, wherein the graphical representations in the storyboard information together define a three dimensional visual representation of the physical environment(s) or objects in which the business process takes place.

29. A method of documenting and presenting business process information, the method comprising:
providing a computing device;
using a data input application implemented by the computing device to define business process information;
providing a plurality of user selectable industry value maps, each industry value map defining a library of metric information and graphical representations relevant to a particular industry;
selecting an industry value map by a user;
using information and graphical representations associated with the selected industry value map to define a framework to support a business conversation; and
producing materials using the business process information defined by the user according to the framework at least partly populated using the industry value map.

30. A method as claimed in claim 29, comprising using the data input application to define a business opportunity that is perceived to exist for a user in relation to a client.

31. A method as claimed in claim 29, comprising using the data input application to define a strategy to be used by the user to present the business opportunity to the client.

32. A method as claimed in claim 31, comprising generating a strategy document, a storyboard document and/or a script document usable to guide the user in a business conversation with the client during which the business opportunity is presented to the client.

33. A method as claimed in claim 1, comprising defining a problem that the client is perceived to have, the difficulties that the client is experiencing overcoming the problem, and the benefit believed to exist for the user in providing a solution to the client's problem.

34. A method as claimed in claim 33, comprising defining current state information indicative of the client prior to implementing a solution to the problem, and future state information indicative of the expected state of the client after implementation of the solution proposed by the user.

35. A method as claimed in claim 29, comprising entering information indicative of decision makers associated with the client that are likely to be involved with solving the identified problem.

36. A method as claimed in claim 29, comprising defining storyboard information including information indicative of a current state of a client before implementation of the proposed solution to the identified client problem, and a future state of the client after implementation of the proposed solution, each of the current and future state information including at least one graphical representation of a business process item derived from the selected industry value map.

37. A method as claimed in claim 36, wherein the graphical representations in the storyboard information together define a three dimensional visual representation of the physical environment(s) or objects in which the business process takes place.
